(19) United States
(12) Patent Application Publication
(10) Pub. No.: US 2008/0055717 A1
(43) Pub. Date: Mar. 6, 2008

(54) OPTICAL TRANSMISSION FILTER WITH EXTENDED OUT-OF-BAND BLOCKING

(76) Inventors: Atul Pradhan, Pittsford, NY (US); Jay Anzellotti, Rochester, NY (US); Joseph T. Foss, Rochester, NY (US); Ligang Wang, Rochester, NY (US); Turan Erdogan, Spencerport, NY (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/848,649

(22) Filed: Aug. 31, 2007

Related U.S. Application Data
(60) Provisional application No. 60/841,551, filed on Sep. 1, 2006.
(60) Provisional application No. 60/841,552, filed on Sep. 1, 2006.
(60) Provisional application No. 60/875,359, filed on Dec. 18, 2006.

(51) Int. Cl. G02B 5/28; C03C 17/06

(52) U.S. Cl. 359/360; 359/359; 427/160

(57) ABSTRACT

In accordance with the invention, a filter is fabricated by a modified form of the process disclosed in U.S. Pat. No. 7,068,430. In particular, the method is modified to take into account the effect of absorption by filter material. The method is exemplified by the fabricating of an ultraviolet light transmission filter for transmitting a band within the range 230-320 nanometers. The resulting filter comprises plurality of hard-coating, thin-film layers of alternating high and low index of refraction. The improved filter provides high transmission, sharp edge slopes, and deep and extended out-of-band blocking. As compared with currently available filters, the filter provides transmission up to three or more times greater, edge slopes up to four times sharper, and deep extended out-of-band blocking extending further, even through the visible range.

### CROSS-REFERENCE TO RELATED APPLICATIONS

This application claims the benefit of U.S. Provisional Ser. No. 60/841,551 filed Sep. 1, 2006 and entitled Optically Transmitting Filters in the Wavelength Region of 230-320 nm., U.S. Provisional application Ser. No. 60/841,552 filed Sep. 1, 2006 and entitled Single-Coating Flourescence Filter And Three-Coating Filter Set, and U.S. Provisional application Ser. No. 60/875,359 filed Dec. 18, 2006 and entitled Optically Transmitting Filter in Wavelength Region of 230-320 nm with Extended Blocking. The '359, '551 and '552 applications are each incorporated herein by reference.

### STATEMENT REGARDING FEDERALLY SPONSORED RESEARCH

Not Applicable.

### FIELD OF THE INVENTION

This invention relates to optical transmission filters and, in particular, to methods of making improved transmission filters and the resulting improved products and improved equipment that they permit. The invention is particularly useful for filters, such as ultraviolet light filters, for which completely transparent filter materials are not available.

### BACKGROUND OF THE INVENTION

Optical transmission filters are useful in a wide variety of applications including spectroscopy and fluorescence microscopy. Filters are used in these applications to block unwanted light that would otherwise manifest as spurious light that could swamp the signals to be detected or distort the images to be seen.

Optical transmission filters typically transmit a desired range of wavelengths (referred to as a transmission band) and block wavelengths outside the transmission band (out-of-band wavelengths). Ideally they would transmit all light within a desired band and block all light outside the band. In reality, in-band transmission incurs some attenuation and out-of-band blocking is incomplete. Moreover, the spectral extent of blocking is limited, i.e. blocking may substantially diminish for light of wavelengths not far removed from the transmission band.

Referring to the drawings, FIG. 1A schematically illustrates the spectral transmission of an ideal optical transmission filter. An ideal filter would transmit all light having wavelengths within a band between a low wavelength [symbol] _{L} and a high wavelength [symbol] _{H} (the Transmission, T, is equal to 1). An ideal filter would block all light outside the band (T=0). [symbol] _{L} and [symbol] _{H} are the wavelengths at which the filter transitions between blocking and transmitting.

Real filters invariably block a small portion of the light to transmitted (T<1) and transmit a small portion of the light to be blocked (T>0). Moreover, the blocking may become less effective for wavelengths spectrally away from the transmission band. These properties are schematically illustrated in FIG. 1B showing the effect of a filter with less than perfect transmission, finite transition regions, less than perfect blocking, and out-of-band transmission. The proportion of light transmitted, the steepness of the transition lines and the extent of the blocking are important parameters in many applications.

Transmission filters are particularly important in optical measurement and analysis systems. Some such systems, e.g. fluorescence systems, use light of one wavelength to excite a sample of material and then measure or view an optical response of the excited sample at another wavelength. The excitation light is delivered to the sample by an excitation light path, and the optical response of the sample is delivered to the eye or measuring instrument by a collection path. Transmission filters between the source and the sample can be used to block spurious light from the excitation path. The steeper the filter transition lines, the more effectively spurious signals are blocked. The lower the transmission loss, the more light from the desired excitation band reaches the sample. Moreover, if the optical response being measured differs considerably in wavelength from the excitation light, the transmission filter needs extended out-of-band blocking to prevent transmission of spurious light that can scatter into the collection path.

UV fluorescence spectroscopy is based on the fact that when some materials are excited by ultraviolet light (light that is composed of wavelengths too short to be visible) they respond by the emission of near-UV and/or visible light (“fluorescent light”). In such apparatus it is important that the UV excitation path not transmit visible light that can also be transmitted as a spurious signal through the collection path.

FIG. 2 is a simplified schematic diagram of a UV probe 20 designed to excite a sample 21 by UV light and to collect visible fluorescent light from the sample. In essence, the probe comprises a UV source 22, an excitation path 23 for transmitting the UV light to the sample 21 and a collection path 24 for transmitting the fluorescent response light from the sample 21 to a detector 25. The excitation path 23 for UV light ideally transmits only UV light that will excite specific materials (“markers”) in the sample. In reality, UV light sources may include or can generate spurious visible light by a number of mechanisms. The spurious visible light can scatter off the sample 21 into the collection path 24 to the detector.

Absorption spectroscopy is another optical analysis technique used in identifying materials and quantifying concentrations. In absorption spectroscopy light of one or more discrete bandwidths is transmitted through a first path and through a sample. Light from the illuminated sample is transmitted through a collection path to a detector that can measure the amount of light the sample absorbed. The amount of absorption provides information regarding the identity of unknown materials or the concentration of known materials. Spurious light through the first path can provide incorrect or inaccurate results.

It should be clear that the steeper the filter slope at the transition wavelengths [symbol] _{L}, [symbol] _{H}, the greater the amount of unwanted light that can be filtered out, avoiding spurious results. The greater the in-band transmission of the filter, the greater the input of desired light. And the greater the extent of out-of-band blocking, the less spurious light at the output to interfere with measurement or viewing.

Systems using UV excitation light, particularly UV bands in the wavelength range 230 to 320 nanometers, are particularly useful. The term “bands within the wavelength range” as used herein is intended to include smaller wavelength bands included within the range, e.g. 250-270 nanometers, as well as bands that encompass the range, e.g. 220-325 nanometers. Bands within the 230-320 wavelength range have attained prominence for use in biomedical applications as diverse as drug discovery, genomics and proteomics, immunology, chemical process tracing and threat biodetection. UV bands in this range are highly useful in the fluorescent detection of nucleotides, proteins and enzymatic molecules.

Unfortunately existing filters and equipment leave much to be desired for bands within the 230 to 320 nanometer range. Few commercial filters are available in the range, and none provide the combination of high transmission, steep edge slopes and deep, extended out-of-band blocking needed for high performance detection and measurement.

Typical commercial filters are metal-dielectric filters and soft-coating thin film filters. Metal-dielectric filters provide relatively low transmission: typically only 10-30%. The low-transmission in such filters is inherent because transmission performance is inversely related with achievable blocking.

“Soft-coating” thin-film filters, as well as those that achieve partial blocking using colored absorbing glasses, are not suitable for high intensity light sources in the 230-320 nanometer range. In the UV range, soft-coating materials suffer from severe reliability, durability and spectral stability issues. Even moderate amounts of illumination by high intensity UV sources can cause soft coatings and colored substrates to “burn out”, solarize or photodarken.

A new approach to making highly discriminating optical filters and the resulting improved products are disclosed in U.S. Pat. No. 7,068,430 which is incorporated herein by reference. This approach offers considerable promise for application to filters for the visible range where essentially transparent materials are available. The present invention is an extension and modification of the '430 method to produce advantageous filters for shorter wavelengths where completely transparent materials are not available.

### SUMMARY OF THE INVENTION

In accordance with the invention, a filter is fabricated by a modified form of the process disclosed in U.S. Pat. No. 7,068,430. In particular, the method is modified to take into account the absorption of short wavelengths by filter material. The method is exemplified by the fabricating of an ultraviolet light transmission filter for transmitting a band within the range 230-320 nanometers. The resulting filter comprises plurality of hard-coating, thin-film layers of alternating high and low index of refraction. The improved filter provides higher transmission, sharper edge slopes, and deeper and extended out-of-band blocking. As compared with currently available filters, the filter provides transmission up to three or more times greater, edge slopes up to four times sharper, and deep out-of-band blocking extending into and even through the visible range.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIGS. 1A and 1B are schematic illustrations of the spectral transmission of ideal and real optical transmission filter;

FIG. 2 is a simplified schematic diagram of a UV probe to excite and collect optical fluorescence from a sample;

FIG. 3 schematically illustrates an improved optical transmission filter

FIG. 4 is a schematic view of a computer-controlled deposition apparatus useful in making filters;

FIG. 5 is a process flow chart for making the long-wave pass component of a filter;

FIG. 6 is a process flow chart for making the short-wave pass component;

FIG. 7 is a graphical illustration of the theoretical and measured transmission spectra of a exemplary filter;

FIG. 8 illustrates the optical density spectrum of the exemplary filter; and

FIG. 9 is a table giving the index of refraction for HfO2 at wavelengths of interest.

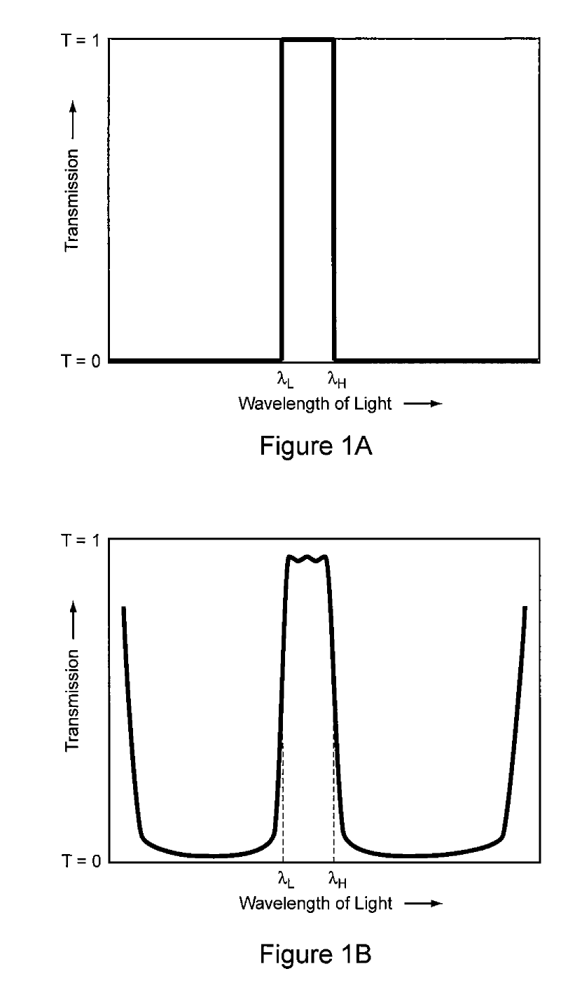

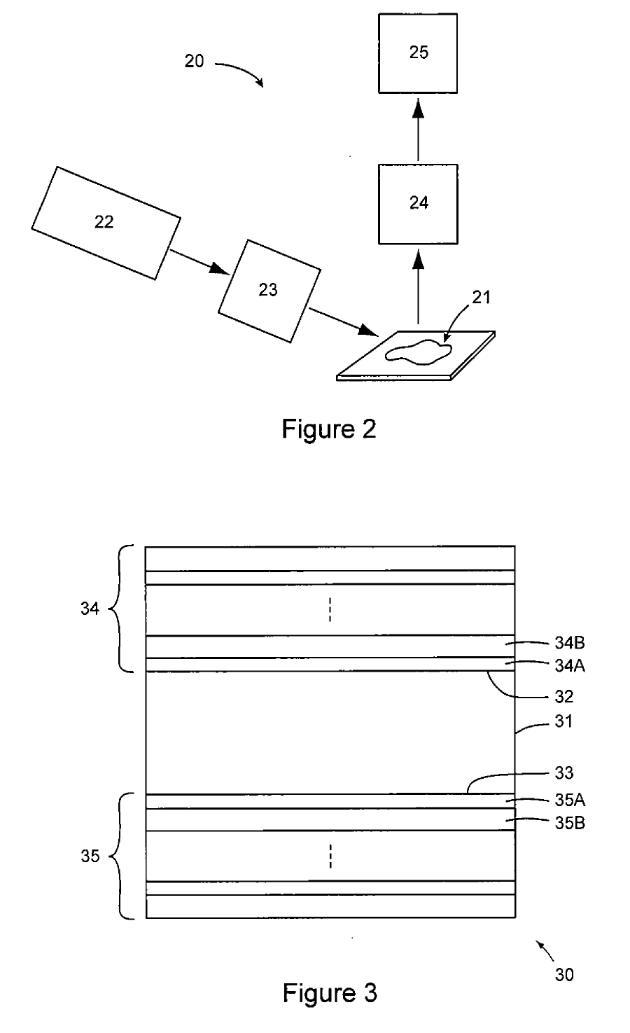

It is to be understood that these drawings are for purposes of illustrating the concepts of the invention and, except for data graphs, are not to scale.

### DETAILED DESCRIPTION OF THE INVENTION

Referring to the drawings, FIG. 3 schematically illustrates an improved optical transmission filter. The filter 30 comprises a substrate 31 having one or more surfaces 32 and 33 for supporting thin film hard coatings. The support surfaces 32, 33 are typically opposing optically smooth, planar major surfaces of a thin substrate. The hard coatings forming the transmission filter (e.g. interference filter components 34, 35) can overlie respective surfaces 32, 33 or they can both overlie the same surface. See U.S. Provisional Patent Application 60/841,552 incorporated herein by reference. In the embodiment illustrated a first interference filter component 34 is disposed overlying a first surface 32 and a second interference filter component 35 is disposed overlying the second surface 33. The first filter component 34 comprises alternating layers 34A, 34B of at least two materials of relatively higher refractive index (34A) and relatively lower refractive index (34B), respectively, to form a long wavelength pass filter component that transmits the passband wavelengths but blocks wavelengths below the passband. The second filter component 35 comprises alternating layers 35A, 35B of at least two materials of relatively higher refractive index (35A) and relatively lower refractive index (35B) to form a short wavelength pass filter component that transmits the passband wavelength but blocks wavelengths above the passband. The first and second filter components thus cooperate to transmit light within the passband and to block light outside the passband. One or both of the materials may be materials that absorb small, but not negligible, amounts of light within the passband wavelengths.

In a preferred embodiment, the filter 30 has a passband of ultraviolet light within the range of 230 nanometers to 320 nanometers. The substrate 31 is substantially transparent to ultraviolet light, and the first and second interference filters 34, 35 comprise hard coatings of non-metals that may absorb small amounts of ultraviolet light. Typically, the filters 34, 35 each comprise 30 or more alternating layer pairs. The substrate is advantageously fused silica or calcium fluoride, and the coatings preferably comprise alternating layers of silica and hafnia.

The improved filters described herein are advantageously made by a data processor-controlled deposition system. The preferred deposition system is an ion beam sputtering deposition system using an ion beam assist source for depositing hard coatings combined with an integral optical monitoring system for monitoring deposition. A data processor, responsive to signals from the monitoring system, processes the signals and directs the growth of the layers.

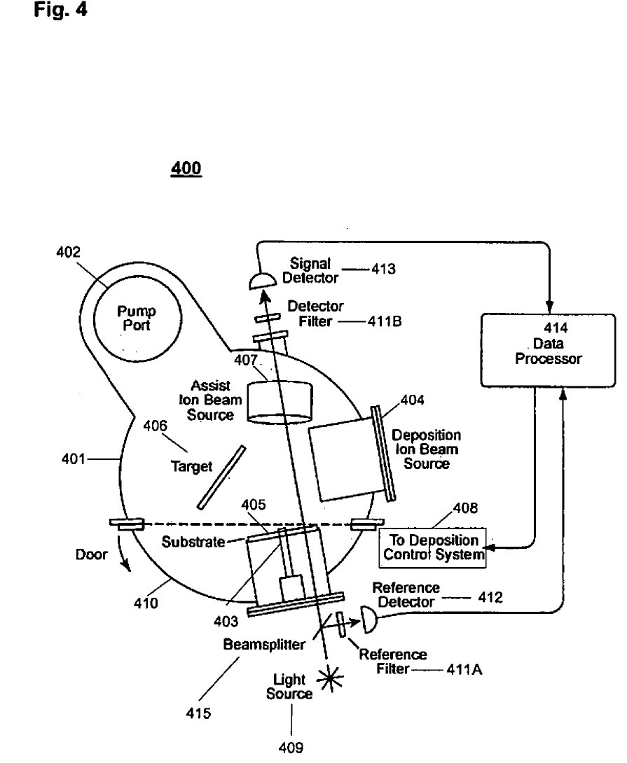

FIG. 4 is a schematic view of an advantageous data processor-controlled deposition apparatus 400 for making the filter by ion beam sputtering disposition with optical monitoring under data processor control. The apparatus 400 comprises a vacuum chamber 401 having an interior accessible by a sealable port 402 such as an o-ring sealed door. The chamber 401 includes a pump port 402 for coupling to one or more evacuating pumps (not shown) such as mechanical and low pressure cryogenic pumps.

Within the chamber 401 is a substrate mount 403 which is advantageously a rotatable spindle mount. Also within the chamber are a plurality of material targets, a deposition ion beam source 404, and a mounted substrate 405. One of the targets 406 is positioned in relation to the ion beam source and the substrate so that an ion beam from the source will sputter material from the target onto the substrate in a substantially uniform layer. Typically there are separate targets for each material to be deposited on the substrate, and the targets are moveable to and from the sputtering position. There are usually two material targets: one for depositing a high optical index material, such as hafnia (HfO2), and the other for depositing a low index material, such as silica (SiO2). The targets are moveable so that deposition can be switched automatically from one material to the other. An Hf metal target can be used during the hafnia deposition and is preferably chosen to have Zr contamination of less than 0.8%.

An assist ion beam source 407 is disposed in the chamber 401 in position to bombard the substrate 405 with an ion beam. Normally during the deposition of any one material, the substrate is simultaneously bombarded by sputtered material and by ions from the assist ion beam source 407. See J. M. E. Harpe et al., “Modification of Thin Film Properties by Ion Bombardment During Deposition,” in Ion Bombardment Modification of Surfaces, Ed. By O. Auciello and R. Kelly, from Beam Modification of Material, Vol. 1 (Elsevier, Amsterdam, 1984).

In the preferred embodiment of this invention using hafnia and silica, the assist ion beam is turned off during the deposition of hafnia (HfO₂) and turned on during the deposition of silica (SiO₂). The use of the assist beam during hafnia (HfO₂) deposition results in films with undesirably high crystallinity, absorption (due to hafnia layers with extinction coefficient >1×10⁻³), and scatter. We have further found that an important factor for reducing the UV extinction in thin films of both hafnia and silica is the regulation of flow of O₂ into the deposition chamber. The rate of O₂ injection during deposition determines the stoichiometry of the hafnia and silica layers. In particular, the formation of HfO₂ in the hafnia layer from Hf metal precursor atoms and O₂ molecules has a profound effect on the absorption characteristics of the film. The optimum stoichiometry is achieved with a flow of 12 sccm of O₂ of which 6 sccm are from the target O₂, and 6 sccm from the ion source. These flow settings achieve hyperstoichiometric hafnia thin films with reduced UV absorption.

Both the sputter deposition and the assist bombardment can be activated by a deposition control system 408. The control system 408 can start or stop deposition precisely by turning on and off the deposition ion beam source 404 or by removing or engaging a mechanical shutter (not shown) that covers the substrate. Further details concerning ion beam sputtering deposition systems can be found in U.S. Pat. No. 4,142,958 issued to David Wei et al. on Mar. 6, 1979 and U.S. Pat. No. 4,793,908 issued to Gene Scott et al. on Dec. 27, 1988, both of which are incorporated herein by reference. See also Juergen Becker, “Ion Beam Sputtering,” Handbook of Optical Properties, Vol. 1, Thin Films for Optical Coatings, Ed., by R. E. Hummel and K. H. Guenther (CRC Press, Boca Raton, 1995).

The above depositional process produces low absorption hafnia layers. The hafnia (HfO₂) material layers exhibit a small extinction coefficient of <5×10⁻⁴ leading to low absorption. This low extinction coefficient correlates with a realized O (Oxygen) to Hafnium (Hf) atomic ratio greater than 2.0 (hyperstoichiometry) in the hafnia layers.

It is believed that the presence of excess oxygen in the hyperstoichiometric hafnia (HfO2) reduces optical absorption by quenching dangling bonds in the amorphous-crystalline hafnia (HfO2) layer mixture. Such hyperstoichiometry (N(O)/N(Hf)=2.16) in hafnia layers is also confirmed by a low oxygen to hydroxide ratio (in this case N(O)/N(OH)=1.37) since a correlation of hyperstoichiometry with a oxygen/hydroxide ratio is reported in a previous E-beam evaporated hafnia thin-film study (Optical and Microstructural Properties of Hafnium Dioxide Thin Films, J. P. Lehan, Y. Mao, B. G. Bovard, and H. A. Macleod, Thin Solid Films, 203 (1991) pp 227-250).

In the advantageous arrangement shown here, a beam splitter 415 picks off a portion 416 of the monitoring light beam 417 from source 409 and detects it with reference detector 412. The signal detector 413 detects the portion 418 of the beam 417 that passes through the coated substrate (or a “witness” substrate) being monitored. Advantageously, the filters 411A and 411B are positioned to ensure that a sufficiently narrow band of wavelengths is monitored.

The filters 411A, 411B can be narrow band interference filters, adjustable diffraction-grating monochromators or combinations thereof. Further details concerning optical monitoring of thin films as they are being deposited can be found in U.S. Pat. No. 6,649,208 issued to Wayne Rodgers on Nov. 18, 2003, which is incorporated herein by reference. See also H. Angus Macleod, Thin Film Optical Filters (3^{rd} Ed., Institute of Physics, Bristol, 2001) and H. A. Macleod, “Turning Value Monitoring of Narrow-Band All-Dielectric Thin-Film Optical Filters,” Optica Acta. Vol. 19, pp. 1-28 (1972).

The data processor 414 collects data from the signal and reference detectors 413, 412, implements the mathematics associated with optical monitoring algorithms and instructs the deposition control system 408 when to stop depositing any given thin film layer based on the result of the mathematical calculations prescribed by algorithm.

The manner in which the data processor 414 controls the apparatus 400 via the deposition control system 408 to generate the optical filters according to the present invention will now be described. In particular, the data processor 414 is programmed to instruct the apparatus 400 when to stop depositing each layer of the optical filter being manufactured. The data processor 414 follows two separate processes in determining when a deposition of a layer should terminate depending upon whether a long-wave-pass component or a short-wave-pass component is being manufactured. These two processes will be described in turn.

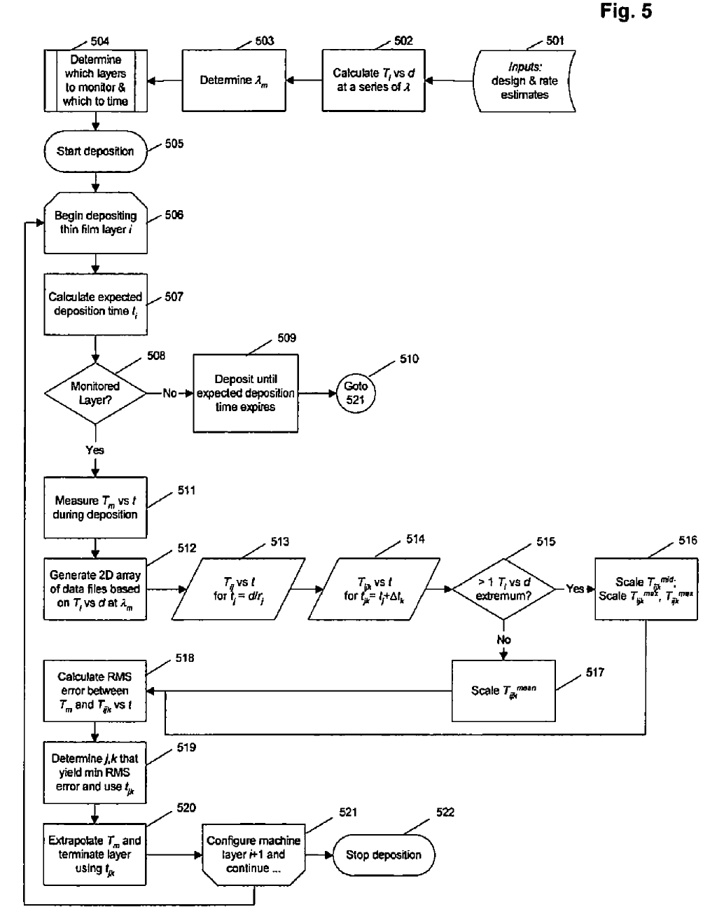

FIG. 5 illustrates the process flow executed by the data processor 414 when manufacturing a long-wave-pass (“LWP”) filter component. However, prior to initiating the process of FIG. 5, a design for the LWP filter is prepared. In the exemplary embodiment, the LWP filter has N layers (typically N≧30) and comprises at least two materials: a relatively lower-refractive-index material and a relatively higher-refractive-index material. The exemplary initial design for a steep LWP edge filter includes a quarter-wave (“QW”) stack of (0.5H L 0.5H)̂N where L and H represent layers of high and low index materials with a quarter-wave of optical thickness at the reference wavelength. The reference wavelength is chosen so that the longer-wavelength edge of the QW stopband is close to the desired transition wavelength of the LWP filter component.

Once the initial design is setup, a desired target spectrum is constructed, which typically includes the wavelength ranges of both the blocking and passband regions, as well as the required blocking level and minimum transmission and allowable ripple within the passband. The edge steepness is thus indirectly defined as the wavelength separation between the blocking region and the passband.

The layer thicknesses of the initial design are then optimized against the target spectrum by an optimization routine known in the art. Exemplary optimization routines include the variable-metric or simplex methods implemented in standard commercial thin-film design software packages, such as TFCalc by Software Spectra, Inc., and The Essential Macleod by Thin Film Center Inc. Usually, with the proper choice of the initial design, the optimization quickly converges and the optimized structure is not very different from the initial structure. Special treatments are required for the first layer (toward substrate) and the last layer. The metric thickness of the first layer should be required to meet a minimum thickness threshold, typically 10 nm, in order for robust control by the optical monitoring algorithm. As for the last layer, it sometimes becomes too thin and, consequently, should be eliminated. The structure should be re-optimized whenever there is any modification to the layer thickness.

In preparing the initial design of the long wave pass filter component, it is important to take into consideration the effect of fabrication conditions on the applied layers. The indices of refraction of the applied materials, particularly in UV long wave pass filters, are functions of temperature, pressure and thermal treatment. Here the materials are coated on a substrate typically held at an elevated temperature (roughly 150° C.) in a near vacuum atmosphere. Moreover the deposited materials are, after deposition, typically finished by annealing (baking) them at an elevated temperature for several hours—typically 425° C. for 2-4 hours. The result is that the index after fabrication is different than the index during fabrication. In general, this difference is very small for coatings used in visible light filters and can usually be ignored as negligible. But in UV filters the difference is somewhat larger and should be considered in the initial design, as it affects the optical monitoring process during filter fabrication. Specifically, the coating indices during fabrication should be targeted so that the final indices after deposition, annealing and cooling will be indices desired.

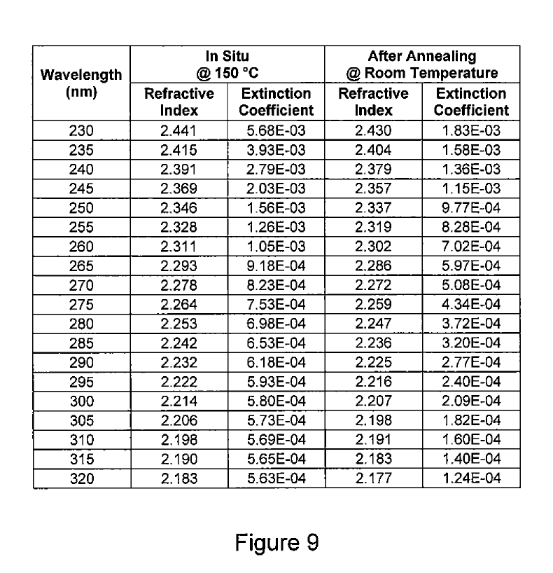

In making the present filters HfO2 is the material most sensitive to fabrication conditions. The correlation at different wavelengths between the index during deposition (“in situ”) and the index at room temperature after annealing is given in the Table set forth as FIG. 9. The indices are specified as complex indices of refraction with the “real part” being the Refractive index and the “imaginary part” being the extinction coefficient. Values for wavelengths not listed may be determined sufficiently accurately by interposition. The variation of the index for SiO2 is not significant for this filter.

In application, the design created uses the after annealing index values. The calculations that are part of the fabrication monitoring process use the “in situ” values so that the end result is in accordance with the design.

With the LWP filter design at hand, the data processor 414 receives design data and deposition rate data as input at 501. The design data describes the designed thin-film structure of the LWP filter with a physical thickness dᵢ and an index nᵢ for each i^{th} layer. nᵢ is either n_{L}, or n_{H}, where n_{L} is the refractive index of the low-index material and n_{H} is the refractive index of the high-index material. n_{L} and n_{H} are each known as a function of wavelength λ. The deposition rate data describes the known starting deposition rate of the deposition apparatus 400 shown in FIG. 4 for each of the two materials. In the exemplary embodiment, the deposition rate data is within about ±5% of the actual deposition rate and is in units of Å/sec. The starting rate estimates for each of the two materials are referred to as r_{L} and r_{H}, and hence each layer will have a starting rate estimate rᵢ depending on whether it is made of low-index or high-index material.

At 502, the transmission Tᵢ, as a function of physical thickness d for each i^{th} layer is calculated at a series of wavelengths in the transmissive band of the finished filter. Consequently, the calculations at 502 result in a series of curves Tᵢ vs. d at each of the series of wavelengths in the transmissive band of the finished filter. Such calculations are performed using standard mathematical methods for calculating the optical properties of thin-film filters. See, for example, H. A. Macleod, Thin-film Optical Filters, 3^{rd} edition (Institute of Physics, Bristol, 2001).

Advantageously, instead of calculating each Tᵢ vs. d curve at one corresponding wavelength in the series of wavelengths, each Tᵢ vs. d curve is calculated by averaging a plurality of Tᵢ vs. d curves calculated at a range of wavelengths surrounding the corresponding wavelength. For instance, assume that the series of wavelengths includes 241 nm and 242 nm. Instead of calculating a Tᵢ vs. d curve at just 241 nm, this Tᵢ vs. d curve is advantageously calculated by averaging Tᵢ vs. d curves calculated at, for instance, 240 nm, 241 nm, and 242 nm. Further, the Tᵢ vs. d curve at 242 nm is advantageously calculated by averaging Tᵢ vs. d curves calculated at, for instance, 241 nm, 242 nm, and 243 nm. One skilled in the art will appreciate that invention is not limited to this averaging procedure and the range of wavelengths used.

At 503, an optical monitoring wavelength λₘ is selected from the series of wavelengths in the transmissive band of the finished filter, thereby identifying a single curve Tᵢ vs. d at λₘ, from the series of curves computed at 502. The monitoring wavelength λₘ, is determined based on the contrast of the monitoring signal within each layer. The contrast is defined as the relative range of the monitoring signal within the layer of interest. The higher the contrast, the more robust the process flow of FIG. 5 will be with respect to random signal noise.

Advantageously, the relative separation between the monitoring and cutoff wavelengths should be at least about 2%. Once above 2%, the monitoring wavelength λₘ should be chosen to maximize the contrast of each layer. In addition, the optical thickness of the first layer toward the substrate has a significant impact on the signal contrast for the rest of the coating. Therefore, the optical thickness of the first layer should be close to three quarter-wavelengths at the monitoring wavelength λₘ.

Having determined the monitoring wavelength λₘ, at 503, processing advances to 504 where it is determined how the deposition duration for each layer will be calculated. For layers that are predicted to have little error between the designed thickness d and a simulated actual thickness, deposition duration is controlled by optically monitoring transmission levels Tₘ through the layer during deposition. For the other layers, their deposition durations are controlled using an expected deposition time tᵢ based upon designed (“theoretical”) thickness dᵢ and deposition rate rᵢ. Accordingly, at 504, the data processor 414 determines which layers are to be optically monitored and which layers are to be timed using an expected deposition time.

To determine which layers will be optically monitored, the data processor 414 enters a simulation mode to simulate deposition of each of the layers of the optical filter. Only the layers 25 that are determined by the simulation to have the least amount of error are selected for optical monitoring. The simulation mode is nearly identical to the process described below with reference to 505 to 522, except that layers are not actually deposited at 505 and 506, the processing described at 508 is skipped, and instead of actually measuring transmission data Tₘ vs. t at 511, it is generated. Tₘ vs. t is generated by adding random noise to the theoretical data Tᵢ vs. d at λₘ from 502 and 503. In the exemplary embodiment, 0.2% peak-to-peak random noise is used, and the maximum amount of error (“threshold”) to select a layer for optical monitoring is to have no more than about 0.2% error from the theoretical thickness dᵢ. The error calculation, in this regard, is discussed in more detail below with reference to 518 and 519. The layers that are simulated to exceed the threshold amount of error are flagged to have their deposition duration controlled by the best estimate of the deposition rate rᵢ for that layer or from an average of the rates of the previous layers of like material (typically 10 to 20 of such layers).

After determining which layers are to be optically monitored at 504, actual deposition of the layers of the LWP filter begins at 505. In particular, the substrate is loaded into the deposition apparatus 400 of FIG. 4, the apparatus is pumped down to a vacuum, and deposition of the first layer (current layer i) is initiated at 506. The expected deposition time tᵢ for layer i is calculated as the desired thickness dᵢ divided by the estimated deposition rate rᵢ for the layer or from an average of the rates of the previous layers of like material at 507. It should be noted, however, that calculation of the expected deposition time tᵢ at 507 may be calculated prior to beginning actual deposition of the current layer i at 506.

After calculating the expected deposition time tᵢ, it is determined whether the current layer i has been identified as a layer to be optically monitored for controlled deposition duration. If the current layer has not been so identified, deposition of the current layer terminates when the expected deposition time tᵢ from 507 expires, as shown at 509. After the expected deposition time tᵢ has expired, processing advances to 521 where the next layer is queued up for deposition, as shown at 510.

If it is determined at 508 that the current layer i is to be optically monitored, the actual transmission Tₘ, is measured at 511 as a function of actual time transpired t until about 95% of the expected deposition time tᵢ has elapsed. Once about 95% of tᵢ has elapsed, a new deposition duration is calculated at 512-520. In particular, at 512, 513, and 514, using the Tᵢ vs. d at λₘ curve from 502 and 503, a two-dimensional (2D) array of additional curves is generated by plotting the values of Tᵢ against a 2D array of time vectors tⱼₖ. In particular, at 513, transmission Tᵢⱼ is generated by plotting Tᵢ against the values tⱼ=d/rⱼ where rⱼ represents, for each j, a deposition rate having a value close to the predicted value rⱼ. That is, the set of all rⱼ values is a range of values surrounding the predicted value rⱼ. Accordingly, j is an index that counts the number of r values that come from the range surrounding the predicted value rⱼ. At 514, for each value of j, transmission Tᵢⱼₖ is generated by plotting Tᵢⱼ against the values tⱼₖ=tⱼ+Δtₖ, where Δtₖ represents various values used for a uniform time shift.

At 515, it is determined whether there is more than one extremum in the curve Tᵢ vs. d at λₘ. If there is more than one extremum at 515, then each of the 2D array of curves generated at 512-514, is scaled in two ways at 516. First, the mid-point between the two extrema for each Tᵢⱼₖ curve is scaled by a factor so that it equals the mid-point between the two extrema of the measured data Tₘ vs. t. Second, the maximum and minimum values on each Tᵢⱼₖ curve are scaled by scaling uniformly about their mean so that the difference between the maximum and minimum for each curve Tᵢⱼₖ is the same as that on the measured curve Tₘ vs. t. If there is one or no extremum at 515, then the mean of each Tᵢⱼₖ curve is scaled at 517 by a uniform factor so that it is equal to the mean of the measured curve Tₘ vs. t.

After scaling at 516 or 517, processing advances to 518 where error is calculated. For each of the 2D array of generated tᵢⱼₖ curves, the root-mean-square (RMS) error between each Tᵢⱼₖ curve and the measured curve Tₘ vs. t is computed. Typically this computation is performed only for data between about 10% and 95% of the expected deposition time tᵢ. Afterwards, the values of j and k that yield a minimum RMS error at 518 are identified at 519. Therefore, the curve Tᵢⱼₖ vs. tⱼₖ is taken to be the best approximation of the actual curve Tₘ vs. t for layer i. At 520, the curve Tᵢⱼₖ vs. tⱼₖ is compared against the design curve Tᵢ vs. d at λₘ from 502 and 503, and the time tⱼₖ at which the layer should be terminated is computed. When the measured time t reaches tⱼₖ, the deposition for the optically monitored layer i is terminated.

After deposition of the current layer i has completed, the apparatus 400 of FIG. 4 is reconfigured at 521 to start depositing the material associated with layer i+1, and the process loops back to 506. However, if all layers of the filter have been deposited, the LWP filter is complete, and processing stops at 522.

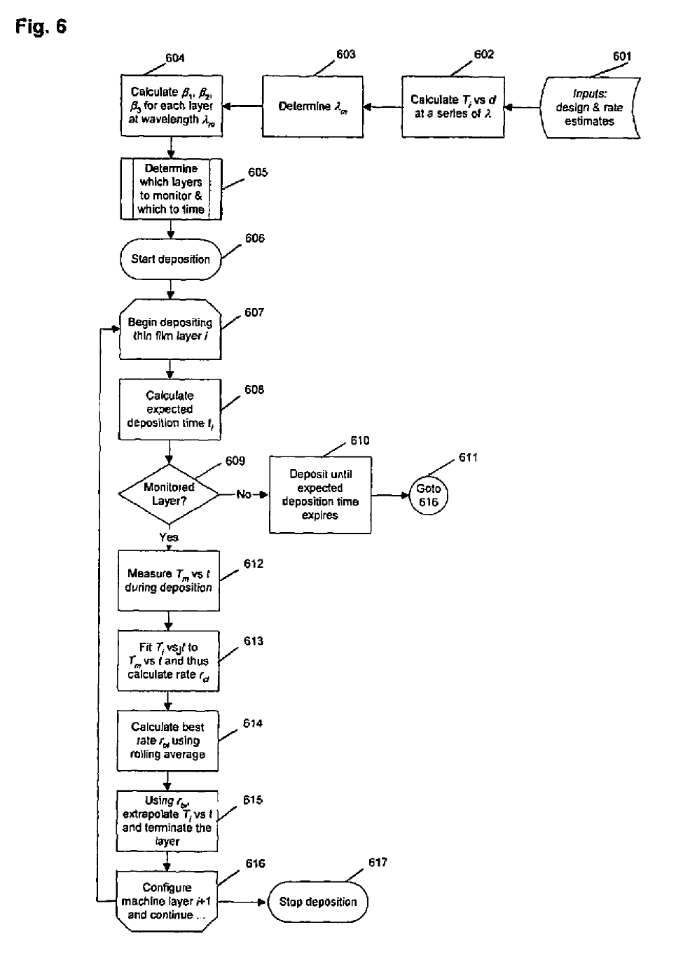

FIG. 6 describes the process flow executed by the data processor 414 when manufacturing a short-wave-pass (“SWP”) filter component. The process illustrated with FIG. 6 is based on the inventor's observation that the inverse of the monitoring trace (i.e., the transmission of the monitoring light as a function of time) within each layer follows a sinusoidal pattern. As will be shown, four parameters, β₁, β₂, β₃, and θₘ₊₁ are needed to fully describe the behavior of the monitoring trace for each layer in the absence of appreciable absorption, whereas a fifth parameter, D, must be included when such absorption is present, as is true for the UV filters of the present invention.

Assume initially that at the monitoring wavelength the incident medium, deposited materials, and substrate are all lossless (practically true in many, but not all, cases). At normal incidence, each layer may be described by its characteristic matrix:

$$[ \begin{matrix}cos θ & - i sin θ / n \\ - in sin θ & cos θ\end{matrix} ] \qquad ( 1 )$$

where n is the refractive index of the layer, θ is the accumulated phase within the layer, and i in equations 1 through 8 (and only in these equations) is the square root of −1, or i=\sqrt{−1}. (It should be noted that although this specification is described in the context of light striking a filter at normal incidence, one skilled in the art will appreciate that this invention also applies to polarized light striking a filter at non-normal incidence.) θ is expressed as:

$$θ = \frac{2 π}{{λ}_{m}} nd \qquad ( 2 )$$

where d is the metric thickness of the layer and λₘ is the monitoring wavelength. Assuming an assembly of m layers have already been deposited, the transmission of the monitoring light within the (m+1)^{st} layer, the present layer, may be expressed as;

$$T = \frac{4 {n}_{a} {n}_{s}}{H} \qquad ( 3 )$$

where T is the level of monitoring signal within the present layer (transmission), and nₐ and nₛ are the refractive indices of the incident medium and substrate, respectively. H is defined as:

H=β₁+β₂ cos(2θₘ₊₁)+β₃ sin(2θₘ₊₁) (4)

β₁, β₂, and β₃, are defined as:

$${β}_{1} = \frac{{n}_{a}^{2} + {n}_{m + 1}^{2}}{2} ( {\vert p \vert}^{2} + \frac{{\vert q \vert}^{2}}{{n}_{m + 1}^{2}} ) + 2 {n}_{a} Re ( {p q}^{*} ) \qquad ( 5 )$$

where Re(pq*) is the Real Part of the product of the complex number p and the complex conjugate of the complex number q. p and q are defined in equation (8) below.

$$\begin{matrix}{β}_{2} = \frac{{n}_{a}^{2} - {n}_{m + 1}^{2}}{2} ( {\vert p \vert}^{2} - \frac{{\vert q \vert}^{2}}{{n}_{m + 1}^{2}} ) & ( 6 ) \\ {β}_{3} = ( \frac{{n}_{a}^{2}}{{n}_{m + 1}} - {n}_{m + 1} ) Im ( {p}^{*} q ) & ( 7 )\end{matrix}$$

Im(pq*) is the Imaginary Part of the product of the complex conjugate of the number p and the complex number q. p and q are defined as:

$$[ \begin{matrix}p \\ q\end{matrix} ] = {\prod }_{l = 1}^{m} [ \begin{matrix}cos {θ}_{l} & - i sin {θ}_{l} / {n}_{l} \\ - {in}_{l} sin {θ}_{l} & cos {θ}_{l}\end{matrix} ] [ \begin{matrix}1 \\ {n}_{s}\end{matrix} ] \qquad ( 8 )$$

where θₗ is accumulated phase in the Iₜₕ layer.

For monitoring wavelengths in the UV between 220 and 320 nm, the incident medium (vacuum or air) can be assumed to be lossless but the deposited materials for the thin-film layers and substrate exhibit absorption with losses due to a non-zero extinction coefficients in imaginary parts of their respective refractive indices. For this reason, the in-situ optical monitoring algorithm is advantageously modified with an envelope slope factor to model the in-situ degradation of transmission monitoring signal (T) vs. optical thickness as well as the modification of the algorithmic fitting parameters to include calculated effects of substrate absorption and material absorption of the depositing film layers and the previously deposited back-side thin-film stack.

Specifically, the right hand expression in Equation (4) is modified to be:

H=[β′₁+β′₂ cos(2θₘ₊₁)+β′₃ sin(2θₘ₊₁)]/[1+Dθₘ₊₁] (9)

where D is an additional in-situ fitted parameter used to model the decrease in transmission due to extinction in the UV for the in-situ depositing layers (taken to be front-side thin-film stack without loss of generality), substrate, and, if applicable, the previously deposited back-side thin film stack.

Further β′₁, β′₂, and β′₃ are given by

$$\begin{matrix}{β}_{1}^{′} = [ {β}_{1} δ + {( 1 - α )}^{2} \frac{{R}_{bR}}{{T}_{b}} ] / ( 1 - α ) & ( 10 ) \\ {β}_{2}^{′} = {β}_{2} \frac{δ}{1 - α} & ( 11 ) \\ {β}_{3}^{′} = {β}_{3} \frac{δ}{1 - α} & ( 12 )\end{matrix}$$

Here β₁, β₂, and β₃ are defined as in equations 5, 6, and 7, and the constant

$$δ = γ + ( 2 α - {α}^{2} ) \frac{( 1 - {A}_{fR} ) {R}_{bR}}{{T}_{b}} \qquad ( 13 )$$

Where T_{b} is the transmittance through the previously deposited back-side thin film stack, R_{bR} is the substrate to back-side reflectance, A_{fR} is the absorption of the front side stack, and α is the substrate single-pass absorption. The constant γ is given by:

$$γ = 1 + \frac{{A}_{fR} {R}_{bR} + {A}_{bR}}{{T}_{b}} \qquad ( 14 )$$

where A_{bR} is the back-side thin film stack absorption.

Based on the above equations, the relationship between the monitoring trace T and the accumulated phase θₘ₊₁ within the present layer is established. The inverse of the monitoring trace is sinusoidal, as demonstrated by the expression for H. Further, only five parameters, β₁, β₂, β₃, θₘ₊₁, and D are needed to fully describe the behavior of the monitoring trace in the present layer. Because the thickness d=r×t, where r is the deposition rate and t is the deposition time, a relationship between T and r or t is also established. If the deposition rate is constant, the accumulated phase θₘ₊₁ is proportional to the deposition rate. Therefore, during the deposition process, the deposition rate may be retrieved with high accuracy by fitting the in-situ measurement of the monitoring trace to the five parameters.

With this groundwork, the process of FIG. 6 will now be described in greater detail. However, prior to initiating the process of FIG. 6, a design for the SWP filter component is prepared. The process of designing a SWP edge filter is very similar to that of the LWP filter, with several exceptions. First, the initial structure is (0.5L H 0.5L)̂N. Second, the shorter wavelength edge of the QW stopband should be aligned with the desired cutoff wavelength. Third, if the first layer next to the substrate is a low index layer, it should be removed.

With the design of the SWP filter at hand, the design data, as well as deposition rate data are received as input at 601. The input data has the content and format described with reference to 501 in FIG. 5. At 602, the transmission curves Tᵢ vs. d at a series of wavelengths for each i^{th} layer are calculated as described with reference to 502 in FIG. 5. Choosing the best monitoring wavelength λₘ at 603 is similar to that described with reference to 503 in FIG. 5, except that it may be more advantageous to select λₘ by taking an average of a series of wavelengths than it is for an LWP filter.

At 604, the β parameters are calculated for each layer at wavelength λₘ using equations (1) through (8) described above. At 605, a determination is made as to which layers should have their deposition duration controlled by optical monitoring and which layers should have their deposition duration timed using an expected deposition time tᵢ. Such determination is made by simulating the deposition of each layer and selecting the layers having the least amount of simulated error to be optically monitored. Deposition of the other layers will be timed using the expected deposition time tᵢ.

The simulation process occurs by executing the processes of 606 to 617 as described below. However, actual deposition does not occur at 606 and 607, the processing described at 609 is skipped, and instead of measuring Tₘ vs. t at 612, it is generated. Tₘ vs. t is generated by adding random noise to the theoretical data Tᵢ vs. d at λₘ from 602 and 603. In the exemplary embodiment, 0.2% peak-to-peak random noise is used, and the maximum amount of error (“threshold”) to select a layer for optical monitoring is to have no more than about 0.5% error from the theoretical resulting thickness dᵢ. The error calculation, in this regard, is described in more detail below with reference to 613. The layers that are simulated to exceed the threshold amount of error are flagged to have their deposition duration controlled by the best estimate of the deposition rate rᵢ for that layer or from an average of the rates of the previous layers of like material (typically 10 to 20 such layers).

Having determined which layers are to be optically monitored at 605, deposition begins at 606. In particular, a substrate is loaded into the deposition apparatus 400, the apparatus 400 is pumped down to vacuum, and deposition of the first layer (current layer i) is initiated at 607. At 608, the expected deposition time tᵢ for layer i is calculated as the desired thickness dᵢ divided by the estimated deposition rate for the layer rᵢ or from an average of the rates of the previous layers of like material. It should be noted, however, that calculation of the expected deposition time tᵢ at 608 may be calculated prior to beginning actual deposition of the current layer i at 607.

At 609 it is determined whether the current layer i was identified as an optically monitored layer at 605. If not, deposition occurs until the expected deposition time tᵢ expires, and the deposition apparatus is configured for deposition of the next layer, as shown at 610, 611, and 616. If it is determined that the current layer i is an optically monitored layer at 609, the transmission Tₘ of the current layer is measured at 612 as a function of actual time t transpired, thereby producing a measured curve Tₘ vs. t, until about 95% of time tᵢ has elapsed. Once about 95% of the time tᵢ has elapsed, a new layer time is calculated at 613 to 615.

To elaborate, at 613, Tᵢ vs. t (where t=d/r and Tᵢ vs. d at λₘ was calculated and selected at 602 and 603, respectively) is fit to the measured curve Tₘ vs. t from 612. The Tᵢ vs. t curve is fit to the measured curve Tₘ vs. t by using a function that minimizes the error between the two curves by varying β₁, β₂, β₃, and the deposition rate r. An example of such a function is the Levenberg-Marquardt method implemented under the name “mrqmin( )” in the book Numerical Recipes in C: The Art of Scientific Computing, by Press, W. H.; Teukolsky, S. A.; Vetterling, W. T.; and Flannery, B. P., 2nd ed., Cambridge University Press, Cambridge, 1995. These calculations result in a calculated deposition rate for the current layer i, or r_{ci}.

Because of noise in the overall system and the sensitivity of the high-performance SWP filters to small layer-thickness errors, the calculated rates r_{ci} tend to be insufficiently accurate if used directly. Therefore, a “best rate” for each layer, r_{bi}, is calculated at 614 as the average of the calculated rate r_{ci} and calculated rates r_{cj}, r_{c,j+2}, . . . , r_{c,i-4}, r_{c,i-2} for a certain number (i−j)/2 of previous layers of the same material. In other words, the best rate is a rolling average of the current and previous rates from layers of like material within a certain window. Typically, this window includes about 20 layers.

At 615, the best rate r_{bi} is used to calculate the layer termination time tₜ=d/r_{bi}, and the layer is terminated when the clock reaches this time. Once deposition of the current layer is complete, the deposition apparatus 400 of FIG. 4 is reconfigured at 616 to start depositing the material associated with the next layer i+1, and the process loops back to 607. However, if all layers have been deposited, manufacturing of the SWP filter is complete, and the process ends at 617.

The improved filters have the general structure schematically illustrated in FIG. 3 but are made by the processes described herein in connection with FIGS. 5 and 6. In essence, the filters comprise a transparent substrate advantageously having a pair of optically flat planar major surfaces and a plurality of alternating layers of relatively high index and relatively low index materials. The materials are hard oxide coating materials such as SiO₂, Ta₂O₅, Nb₂O₅, HfO₂, TiO₂, and Al₂O₅.

The filters differ from filters described in the '430 patent in that the effect of absorption is accounted for in the design and fabrication. They differ from pre-430 patent conventional filters primarily in the number of layers (more than 30 and typically more than 100) and in that the thicknesses of layers deposited are controlled by the processes of FIGS. 5 and 6 to produce a highly sloped steep edge (edge steepness may be as low as about 0.8% or lower). The edge steepness, in this regard, is measured by dividing (a) the edge width from the 50% transmission wavelength to the optical density 6 (“OD6”) wavelength by (b) the 50% transmission wavelength. Accordingly, lower steepness values indicate greater slope. Optical density (“OD”) is a measure of the blockage encountered by impinging light and is defined as follows:

OD=−log₁₀(T) (15)

where T is the transmittance having a value between zero and one. OD6 therefore corresponds to a transmittance of 10⁻⁶. Advantageously the edge steepness, as defined above, may be less than about 0.58% at 266 nm and 0.78% at 248 nm. However, the edge steepness may be increased if necessary.

In addition, the filters so made exhibit an average transmission well above 40% within the operating range of the passband between 230 and 320 nm. Average transmission of the filters typically exceeds 90% in the operating range greater than 320 nm. The filters thus provide performance exceeding that of the highest performing conventional soft-coating filters with a more robust and durable hard-coated structure.

The invention can now be more clearly understood by consideration of the following example: a UV band transmission filter with extended out-of-band blocking was made employing the design and fabrication process described above. The filter was designed to transmit a band of wavelengths within the range of 230 to 320 nanometers and to provide extended blocking. The substrate was a fused silica plate of thickness 2 mm having a pair of optically smooth planar major surfaces. The LWP and SWP filter components were formed on the respective major surfaces. The filter components comprised stacks of silica and hafnia layers of substantially quarter wave thickness deposited as described herein. To reduce UV absorption the flow of O₂ was controlled during deposition of both silica and hafnia and the assist ion beam used during the deposition of silica was turned off during the deposition of hafnia. The deposition algorithms were modified as described herein to account for the absorption of UV light by the hafnia layers. The thicknesses in the exemplary filters are set forth in Appendix A. The layers are counted from the substrate outward toward air.

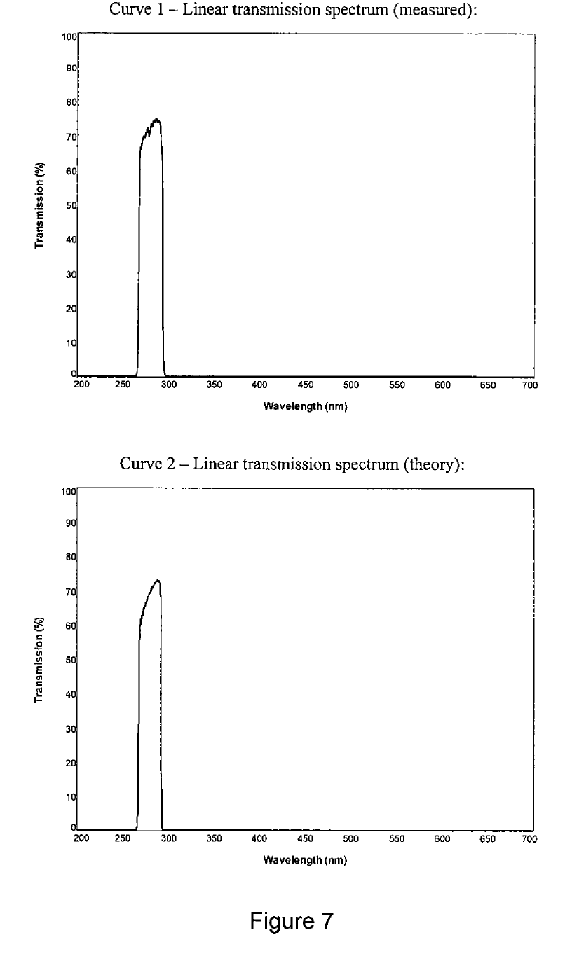

FIG. 7 shows the measured and theoretical transmission spectra of the resulting filter. Curve 1 is the measured spectrum, and curve 2 is the theoretical spectrum.

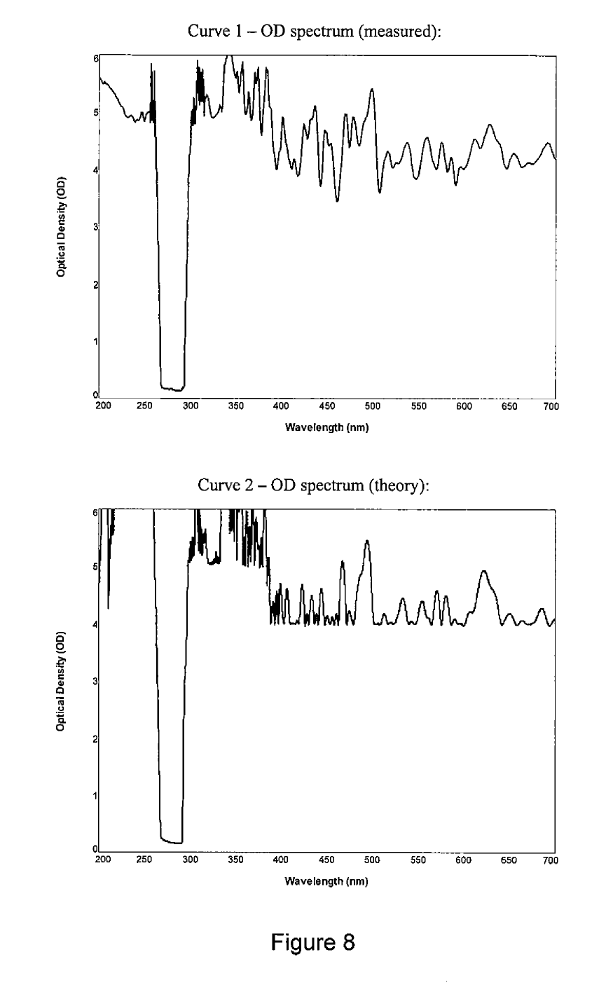

FIG. 8 illustrates the optical density (OD) spectrum of the resulting filter. Curve 1 is the measured spectrum, and curve 2 is the theoretical spectrum. The OD is a measure of the blockage encountered by impinging light. As previously noted, the out-of-band blocking for this UV band transmission filter extends through the visible spectrum. For all wavelengths in the range 230 to 840 nanometers, the filter provides an average optical density of 3 or more. Here average optical density (called OD_{avg}) is defined as

$${OD}_{avg} = \frac{1}{{λ}_{2} - {λ}_{1}} {\int }_{{λ}_{1}}^{{λ}_{2}} Min [ - {log}_{10} ( T ( λ ) ) , 6 ] d λ ,$$

Where Min[a,b] is mathematical notation to indicate that the smaller of the values a and b is to be chosen. The filter also provides an optical density of the average transmission over the wavelength range 320 to 700 nm of greater than 4. Here the optical density of the average transmission (called OD(T_{avg})) is defined as

$$OD ( {T}_{avg} ) = - {log}_{10} [ \frac{1}{{λ}_{2} - {λ}_{1}} {\int }_{{λ}_{1}}^{{λ}_{2}} T ( λ ) d λ ] .$$

### As an example of these calculations, for the filter with measured transmission spectrum shown in curve 1 of FIG. 7 and optical density spectrum shown in curve 1 of FIG. 8, the values of OD_{avg} and OD(T_{avg}) are 4.28 and 4.27, respectively.

The resulting exemplary filter is believed to have characteristics superior to any currently available commercial UV fluorescence filter. It provides transmission up to three or more times greater, edge slopes up to four times sharper, and deep extended out-of-band blocking into and even through the visible range.

Because of the superior characteristics of the filter, superior optical analysis systems can be built. Such a system, as described above, would include a source of excitation light for exciting a sample, a filter in accordance with the invention between the source and the sample and a collection light path from the sample.

While we have exemplified our method and resulting filter as a transmission filter having coatings to produce a low pass filter and a high pass filter on opposing surfaces of a substrate, it should be clear that the same method can be used to fabricate a transmission filter where both coatings (low pass and high pass) are stacked on the same surface of the substrate. The method can also be used to fabricate a transmission filter on one surface of the substrate by hard coatings that form a multi-cavity Fabry-Perot transmission filter. If the coatings are stacked on one surface, the opposing surface can be coated for anti-reflection or to extend blocking of out-of-band wavelengths.

It now can be seen that in one aspect the invention is an optical bandpass filter for transmitting a passband of ultraviolet light. The filter comprises a substrate having one or more surfaces for supporting thin film coatings, a plurality of alternating layers of at least two hard-coating materials of higher refractive index and lower refractive indiex overlying at least one of the surfaces to form a transmission filter. The passband of the filter is a band of ultraviolet light within the range of 230 nanometers to 320 nanometers, i.e. the transmission band of the filter falls within, encompasses or partially overlaps the 230 to 320 nanometer range. The filter has an average transmission of light over the passband exceeding 40% and an average optical density at all wavelengths over the range 230 to 840 nanometers of at least 3.0.

The bandpass filter can comprise a long wave pass filter component and a short wave pass filter component that overlie respective opposing surfaces of the substrate. Alternatively, the long wave pass filter component and the short wave pass filter component can overlie the same surface of the substrate. Or the bandpass filter can comprise a plurality of alternating layers on at least one surface of the substrate forming a multi-cavity Fabry-Perot transmission filter.

In another aspect, the invention comprises an improved optical analysis system comprising a source of excitation light for exciting a sample, an excitation filter between the source and the sample, and a collection light path from the sample. In the improved system, the light source comprises an ultraviolet light source and the excitation filter comprises a filter as described herein.

Yet another aspect of the invention is an improved method of making an optical bandpass filter for transmitting a band of light with extended out of band blocking. The method comprises the steps of providing a substrate having one or more surfaces and forming on one or more surfaces a transmission filter comprising alternating layers of at least two hard coating materials of higher refractive index and lower refractive index. Each of the layers are deposited by a data processor controlled process comprising calculating with the data processor a theoretical transmission Tᵢ of light through the layer, calculating with the data processor an expected deposition time tᵢ of the layer, measuring during the deposition of the layer for a period of time less then tᵢ a measured transmission Tₘ of light through the layer and determining with the data processor when deposition of the layer is to terminate based upon the theoretical transmission Tᵢ and the measured transmission Tₘ. In the improved process, the calculations of tᵢ ant Tᵢ accounts for absorption by the relation of Equations (9) thru (14) herein.

It is to be understood that the exemplary embodiment is merely illustrative of the present invention and that many variations can be devised by those skilled in the art without departing from the spirit and scope of the invention.

1. An optical bandpass filter for transmitting a passband of ultraviolet light comprising:
a substrate having one or more surfaces for supporting thin film coatings;
a plurality of alternating layers of at least two hard-coating materials of higher refractive index and lower refractive index overlying at least one of the surfaces to form a transmission filter wherein;
the passband of the filter is a band of ultraviolet light within the range of 230 nanometers to 320 nanometers, with an average transmission of light over the passband exceeding 40% and an average optical density at all wavelengths over the range 230 to 840 nanometers of at least 3.0.

2. The bandpass filter of claim 1 wherein the alternating layers form a long wave pass interference filter component and a short wave pass interference filter component.

3. The bandpass filter of claim 1 wherein the long wave pass filter component and the short wave pass filter component overlie opposing surfaces of the substrate.

4. The bandpass filter of claim 1 wherein the long wave pass filter component and the short wave pass filter component overlie the same surface of the substrate.

5. The bandpass filter of claim 1 wherein the plurality of alternating layers on at least one surface forms a multi-cavity Fabry-Perot transmission filter.

6. The bandpass filter of claim 1 wherein the optical density of the average transmission at all wavelengths over the range 320 to 700 nm is at least 4.0.

7. The bandpass filter of claim 2 wherein the long wave pass inteference filter component comprises alternating layers of silica and hafnia.

8. The bandpass filter of claim 2 wherein the short wave pass interference filter component comprises alternating layers of silica and hafnia.

9. The bandpass filter of claim 2 wherein the interference filters are composed of hafnia (HfO2) material layers exhibiting a stoichiometric ratio of atomic oxygen to atomic hafnium given as N(O)/N(Hf)>2.

10. The bandpass filter of claim 2 wherein the interference filters are composed of hafnia (HfO2) material layers exhibiting a stoichiometric ratio of atomic oxygen to hydroxide (OH) as N(O)/N(OH)<1.6.

11. In an optical analysis system comprising a source of excitation light for exciting a sample, an excitation filter between the source and the sample, and a collection light path from the sample;
the improvement wherein the light source comprises an ultraviolet light source and the excitation filter comprises a filter according to claim 1.

12. A method of making an optical bandpass filter for transmitting a band of light with extended out-of-band blocking comprising:
providing a substrate having one or more surfaces;
forming on one or more of the surfaces a transmission filter each comprising alternating layers of at least two hard coating materials of higher refractive index and lower refractive index;
each of the layers deposited by a data processor controlled process comprising:
calculating with the data processor, a theoretical transmission Tᵢ of light through the layer,
calculating with the data processor an expected deposition time tⱼ of the layer,
measuring during the deposition of the layer for a period of time less than tᵢ a measured transmission Tm of light through the layer,
determining with the data processor when deposition of the layer is to terminate based upon the theoretical transmission Tᵢ and the measured transmission Tm; and
wherein the calculation of tᵢ and Tᵢ accounts for absorption by the layer by the relation of Equations (9) thru (14) herein.

13. The method of claim 12 wherein the alternating layers form a long wave pass filter component and a short wave pass filter component.

14. The method of claim 12 wherein the alternating layers form a multi-cavity Fabry-Perot filter.

15. The method of claim 12 wherein the at least two deposited materials include silica and hafnia.

16. The method of claim 13 wherein the silica and hafnia are deposited by sputtering.

17. The method of claim 15 wherein the silica is deposited by ion beam assisted sputtering and the hafnia is deposited by sputtering without ion beam assistance.

18. The method of claim 15 wherein the sputtering is conducted in an O₂ ambient with the flow of O₂ chosen to reduce UV light absorption by the deposited layers.

19. An optical bandpass filter for transmitting a passband of light comprising:
a substrate having one or more surfaces for supporting thin film coatings;
a first interference filter overlying one of the surfaces of the substrate comprising alternating layers of at least two materials of higher refractive index and lower refractive index to form a bandpass characteristic;
a second interference filter overlying one of the surfaces of the substrate comprising alternating layers of at least two materials of higher refractive index and lower refractive index to form blocking in addition to that provided by the first bandpass characteristic interference filter;
wherein:
the passband of the filter is a band of ultraviolet light within the range of 230 nanometers to 320 nanometers, with an average transmission of light over the passband exceeding 40%;
the average optical density at all wavelengths over the range 230 to 840 nm is at least 3.0;
the substrate is substantially transparent to ultraviolet light;
the first and second interference filters comprise hard coatings and non-metals that are substantially transparent to ultraviolet light and cooperate to substantially block light with wavelengths outside the passband over a range that includes visible wavelengths.
